(19) United States
(12) Patent Application Publication
(10) Pub. No.: US 2011/0041522 A1
(43) Pub. Date: Feb. 24, 2011

(54) ADAPTER SYSTEM AND METHOD

(76) Inventor: Vincent Carrubba, Belle Harbor, NY (US)

Correspondence Address: MEYERTONS, HOOD, KIVLIN, KOWERT & GOETZEL, P.C., P.O. BOX 398, AUSTIN, TX, 78767-0398, US

(21) Appl. No.: 12/850,407

(22) Filed: Aug. 4, 2010

Related U.S. Application Data
(60) Provisional application No. 61/231,235, filed on Aug. 4, 2009.

(51) Int. Cl. F25B 45/00; B67D 7/08

(52) U.S. Cl. 62/77; 222/153.14; 62/292

(57) ABSTRACT

Various embodiments of adapter systems and related apparatus, and methods of operating the same are described. The adapter of the systems is couplable to an outlet of a fluid source and an inlet of a routing device. The adapter includes a plunger configured to engage an integrated valve of the fluid source and to receive a member of the routing device. The routing device member includes an end capable of breaking a seal. Coupling of the routing device to the outlet may advance the plunger such that plunger engages the integrated valve and at least partially opens the integrated valve.

### PRIORITY CLAIM

This patent application claims priority to U.S. Provisional Patent Application No. 61/231,235 entitled “Adapter System and Method” to Vincent Carrubba filed Aug. 4, 2009, the entire contents of which are incorporated herein by reference.

### BACKGROUND

1. Field of the Invention

The present invention generally relates to an adapter. More particularly, this invention to an adapter for coupling devices to pressurized containers having integrated valves.

2. Description of Related Art

Refrigeration systems (e.g., air-conditioning (A/C) systems) typically include a liquid or gaseous refrigerant that is used for cooling. Servicing a refrigeration system (for example, an automobile refrigerant system, a residential refrigerant system, or a commercial refrigeration system) often includes charging the system with a refrigerant (for example, R-134a, R-12, and other coolants.). In the case of charging an automobile refrigerant system, a pressurized refrigerant source, such as an aerosol can of refrigerant, is connected via a hose to a low-pressure port of refrigerant lines carrying refrigerant within the system. While connected, the refrigerant is expelled from the refrigerant source and is injected or drawn into the refrigerant lines. Refrigerant is added until a desired pressure/volume of refrigerant is provided into the system.

The flow of refrigerant from the refrigerant source is typically regulated via a valve. In the case of an aerosol can of refrigerant, a valve is often threaded or otherwise attached to an outlet at a top end of the container. In some instances, the valve includes a piercing plunger that is advanced to pierce a hole in a seal over an outlet of the can, thereby allowing the pressurized refrigerant to be expelled from the container into the valve. In certain aerosol systems, an integrated valve (for example, a self sealing valve (SSV)) is provided at an outlet of the container. In some aerosol systems, the integrated valve may include a spring-loaded plunger that is depressed to open and close the container. To stop the flow of fluid, the plunger is released, closing the integrated valve, thereby stopping or reducing the flow of fluid.

U.S. Pat. No. 4,535,759 to Giles et al. describes a burner attachment for aerosol containers that has a cylindrical boss with a central well which screws onto the threaded stem portion of the fuel container to an assembled position in which an actuator pin opens a self-sealing outlet valve in the container. U.S. Pat. No. 5,355,830 to de Jong describes a rechargeable air horn that includes an adapter having an opening that is connected to a single open end of a chamber for connection there between. The adapter has a second opposite opening defining a passageway there through. A third opening transverse to the passageway connects an inlet valve to the adapter. The inlet valve may be connected to a conventional tire pump or a built-in pump for refilling the chamber when it has been emptied. An outlet valve is secured to the second opening of the adapter providing a passageway to the membrane of the horn wherein a diaphragm vibrates to sound the horn. The outlet valve may be depressed by an activator to release air from the chamber to the membrane for vibration of the diaphragm.

Although adapters for aerosol products are known and containers having integrated vales are common in many types of aerosol products, they have not typically been used with certain types of products, such as automotive refrigerants. As regulations change, however, it is believed that use of integrated valves may become more common in many, if not all, types of aerosol products. Integrated valves, however, are not readily compatible with certain types of attachments typically used with automotive products and/or other aerosol products. Accordingly, there is a need for devices that enable various styles of valves/attachments to be coupled to containers having integrated valves.

### SUMMARY

Various embodiments of adapter systems and related apparatus, and methods of operating the same are described. In some embodiments, an adapter includes an inlet configured to engage an outlet of a fluid source, the fluid source comprising an integrated valve capable of being moved to an opened position or a closed position; an outlet engageable with an inlet of a routing device; a passage in a body of the adapter, the passage extending between the inlet and the outlet of the adapter; a plunger disposed in the passage, the plunger configured to move the integrated valve of the fluid source from the opened or closed position and to receive a member of the routing device. The routing device member includes an end capable of breaking a seal.

In certain embodiments, a refrigerant source adapter includes a first end configured to couple to an outlet of a refrigerant source having an integrated valve; a second end configured to couple to an inlet of a valve having a piercing tip; a passage that extends between the first end and the second end; and a plunger disposed in the passage. A first end of the plunger may be configured to receive the piercing tip and a second end of the plunger is configured to engage the integrated valve.

In some embodiments, a kit for servicing a refrigeration system is described. The kits includes a routing device comprising a member capable of breaking a seal of a refrigerant source; and an adapter couplable to the integrated valve of the refrigerant source and to the routing device, the adapter comprising a plunger configured to receive the member capable of breaking a seal of a refrigerant source, and a second end of the plunger is configured to engage the integrated valve.

In some embodiments, a method providing an adapter described herein includes providing an adapter to an integrated valve of a fluid source; wherein the adapter comprises a plunger, the plunger having a first end capable of inhibiting a piercing member of a routing device from breaking a seal of the integrated valve; providing the routing device to the adapter; advancing a second end of the plunger into the integrated valve; and allowing fluid to flow from the fluid source to a receiving system coupled to the routing device.

### BRIEF DESCRIPTION OF THE DRAWINGS

Advantages of the present invention will become apparent to those skilled in the art with the benefit of the following detailed description and upon reference to the accompanying drawings in which:

FIG. 1 depicts an expanded schematic of an embodiment of a refrigerant charging system.

FIG. 2 depicts cross-sectional views of embodiments of components of a refrigerant charging system.

FIG. 3 depicts a perspective cross-sectional view of an embodiment of an adapter.

FIG. 4 depicts a perspective cross-sectional view of an embodiment of an adapter with a depressed plunger.

FIG. 5 depicts a cross-sectional view of an embodiment of an adapter connected to a routing device.

FIG. 6 depicts an exploded perspective view of an embodiment of an adapter plunger.

FIG. 7 depicts a flow chart illustrating an embodiment of a method of using an adapter to couple a fluid source with a receiving system.

While the invention is susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION

As used herein, the singular forms “a”, “an” and “the” include plural referents unless the content clearly indicates otherwise. Thus, for example, reference to “a valve” includes a combination of two or more valves. The term “include”, and derivations thereof, mean “including, but not limited to”. “Coupled” means either a direct connection or an indirect connection (for example, one or more intervening connections) between one or more objects or components. The phrase “directly connected” means a direct connection between objects or components such that the objects or components are connected directly to each other so that the objects or components operate in a “point of use” manner.

Systems, methods, and apparatus for adapting an inlet of a routing device to a fluid (for example, a pressurized liquid or gas) source are described herein. As used herein, “fluid” refers to a liquid, gas, vapor, or a mixture thereof. In some embodiments, the fluid source includes an integrated valve. In some embodiments, the fluid source is pressurized or under vacuum. For example, a fluid source may be an aerosol/pressurized can having an integrated valve.

In some embodiments, one or more routing devices may allow fluid to flow from the fluid source to a receiving system. Routing device may include one or more valves, hose, pressure gauges, check valves, conduit, hose adaptors, or combinations thereof. For example, the adapter may connect to a pressurized refrigerant can and a routing device coupled to a refrigeration system. In some embodiments, the routing device is a valve. In certain embodiment, the routing device is a hose or conduit having a shoulder that connects to the adapter. A valve may be connected between the hose and a refrigeration system. In some embodiments, valves may be used for regulating the flow of fluid (for example, a refrigerant) from the fluid source (for example, a refrigerant container) to a refrigeration system.

The routing device may include a piercing pin. Fluid sources having integrated valves are not readily compatible with certain types of attachments, such as valves that include piercing pins, commonly used with automotive products or other types of aerosol products. Such piercing valves are not useful when regulating fluid from a fluid source having an integrated valve because the piercing member of the valve may permanently damage the gating device and/or the seal of integrated valve of the fluid source when the valve is opened and/or closed. One or more adapters described herein allows a routing device having a member capable of breaking a seal (for example, a piercing pin) to be used with various types of containers.

In certain embodiments, the adapter includes a plunger or similar mechanism for engaging the integrated valve and/or a complementary plunger of the integrated valve of the fluid source to enable fluid to flow from the fluid source. In some embodiments, the plunger of the adapter is biased to a closed position and is movable into an open position. Moving the plunger to an open position may engage the integrated valve and/or a plunger of the integrated valve into an open position.

In certain embodiments, the adapter plunger is moved into the open position by engagement (for example, coupling and/or advancement) of a routing device onto the adapter. In some embodiments, the routing device includes a valve having a member capable of breaking a seal. For example, a piercing valve having a piercing plunger. The piercing plunger may be used to break a seal of a fluid source. For example, piercing a hole into a sealed outlet of a pressurized fluid source (for example, a refrigerant container). In certain embodiments, the adapter allows a routing device having a member capable of breaking a seal to be used with various types of containers. For example, fluid sources that include integrated valves.

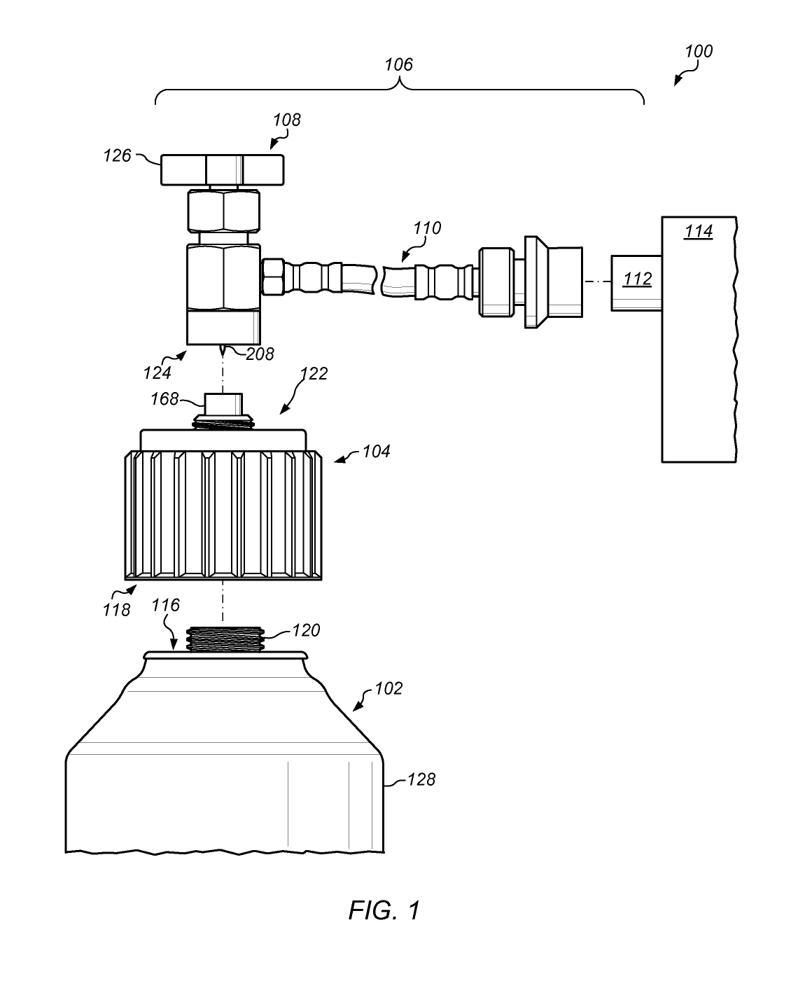

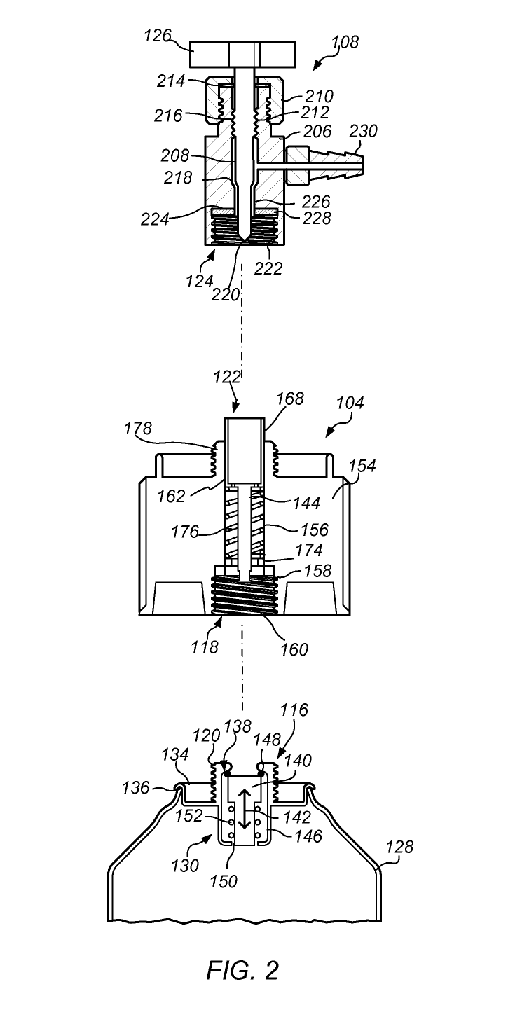

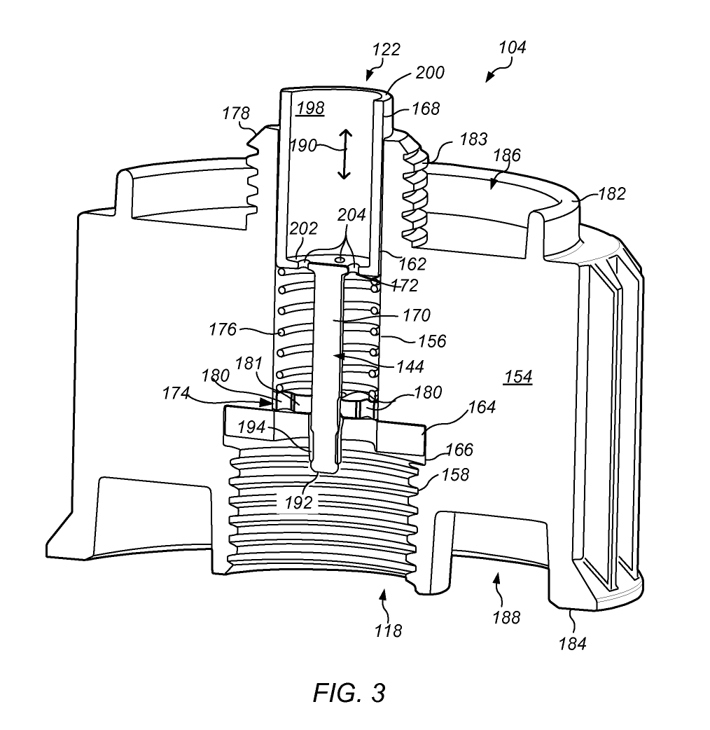

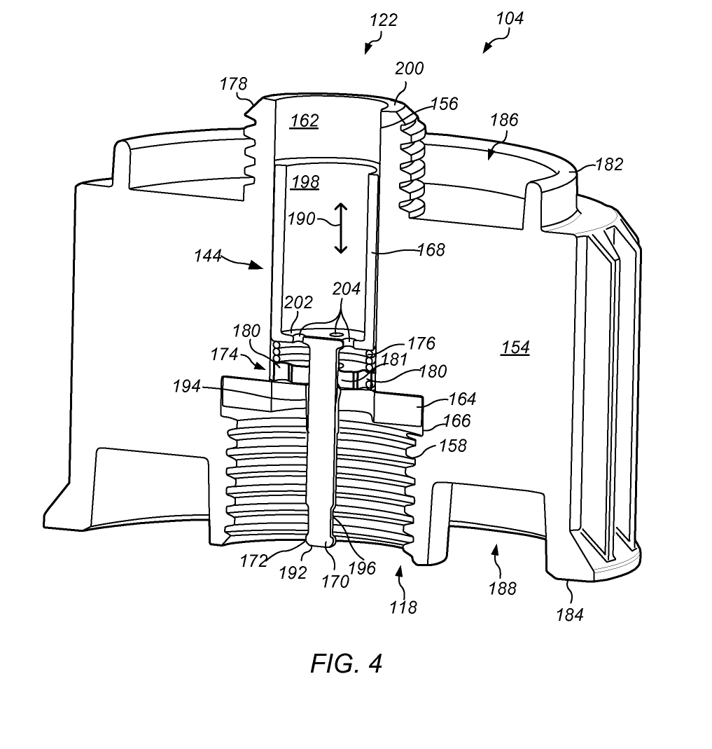

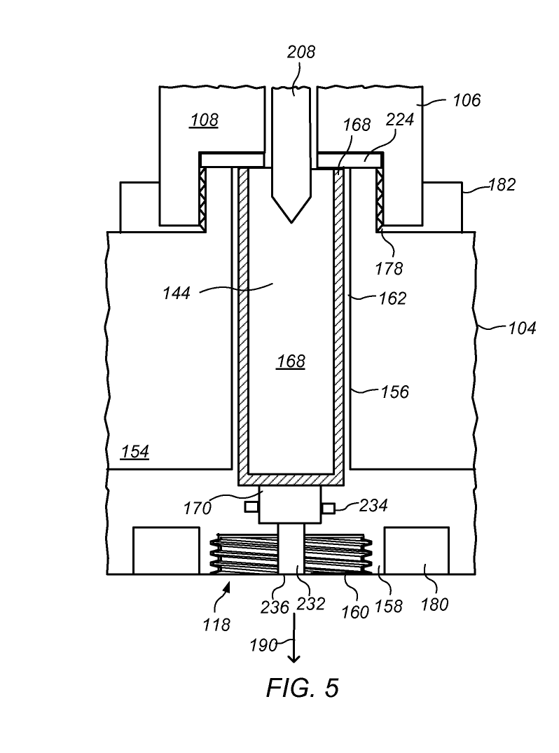

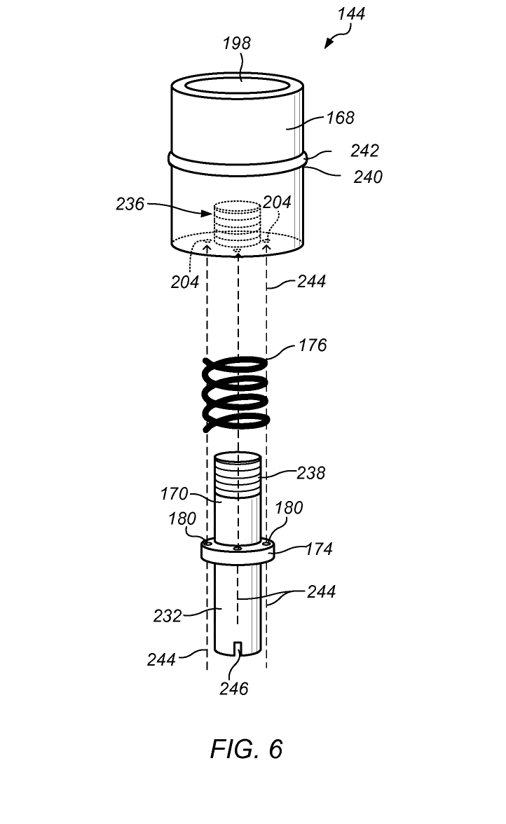

FIGS. 1-6 depict embodiments of the adapter used for adapting a routing device to fluid source containing an integrated valve. FIG. 1 depicts an expanded schematic of an embodiment of connecting a charging system to a refrigeration system. FIG. 2 depicts a cross-sectional view of portions of charging system 100. FIG. 3 depicts a perspective cross-sectional view of an embodiment of an adapter. FIG. 4 depicts a perspective cross-sectional view of an embodiment of the adapter with a depressed plunger. FIG. 5 depicts a cross-sectional view of an embodiment of an adapter connected to a routing device. FIG. 6 depicts an exploded perspective view of an embodiment of an adapter plunger.

As shown in FIG. 1, charging system 100 includes fluid source 102, adapter 104, and routing device 106. Routing device 106 may include valve 108 and/or hose 110. An end of routing device 106 may be coupled to port 112 of receiving system 114. In some embodiments, receiving system 114 is a refrigeration system. Hose 110 may be coupled to valve 108 and to port 112. Port 112 may allow fluid to be added receiving system 114. In some embodiments, routing device 106 includes a hose/conduit integrated with device capable of coupling to the adapter (for example, a hose with shoulder or conduit that includes a valve). As shown, adapter 104 is coupled to fluid source 102 and routing device 106 via valve 108. In some embodiments, a hose and/or conduit may be connected directly to adapter 104. In certain embodiments, a refrigerant (for example, R-134a, R-12, or the like) may be added to refrigeration system using charging system 100.

Receiving system 114 may include, but is not limited to, an automobile refrigerant system, a residential refrigerant system, or a commercial refrigeration system, or the like. In some embodiments, receiving system 114 is an automobile refrigerant system. The automobile refrigerant system may include an automobile air-conditioning (A/C) system. In some embodiments, a refrigeration system may include an evaporator, condenser, and compressor that circulates refrigerant to cool or otherwise transfer/remove heat from the respective environment.

Adding of fluid to receiving system 114 may charge or recharge the unit. As used herein “charging” refers to both charging and recharging of a system. Charging a system may include initially filling a unit with fluid. Recharging may refer to adding fluid to a unit that has some fluid in the unit. Recharging may be performed after a portion of the fluid has leaked out of the unit or the pressure/amount of the fluid has dropped below a desirable level. It will be appreciated that charging and recharging are often used interchangeably. In some embodiments, system 100 is used to charge or recharge a refrigeration system (for example, charging an automobile refrigeration system using a can of refrigerant).

In some embodiments, fluid source 102 includes a source of fluid suitable for use in receiving system 114. For example, fluid source 102 may include a volume of R-134a, R-12, or the like. In certain embodiments, fluid source 102 is a portable container. A portable container includes, but is not limited to, a can, a bottle, or a reservoir that may be easily handled by a user. In some embodiments, fluid source 102 includes, but is not limited, to, a stationary reservoir, such as a large tank or similar container. As shown, fluid source 102 includes body 128 (for example, a pressurized refrigerant container). Fluid source 102 may be pressurized or, in some embodiments, under a vacuum. In some embodiments, fluid source 102 is at atmospheric pressure. In an embodiment, fluid source 102 is an aerosol container of R-134a refrigerant. Fluid source 102 may include outlet 116. Fluid source outlet 116 may allow refrigerant to exit fluid source 102. In some embodiments, fluid source outlet 116 includes an integrated valve having a gating device. A gating device may include a biased plunger that is movable between an open position (for example, where refrigerant is allowed to exit the fluid source container) and a closed position (for example, where refrigerant is inhibited from exiting the fluid source container). Such an integrated valve may be manipulated to the closed position, the open position, or any position there between to regulate the flow rate and/or pressure of refrigerant being expelled from fluid source 102.

In some embodiments, fluid source outlet 116 is connected (for example, couples or directly connects) to an adapter, valve, hose, or the like. Fluid source outlet 116 may connect to adaptor 104. Adapter 104 includes an inlet that is complementary to fluid source outlet 116. Adapter 104 may be coupled to fluid source outlet 116 using coupling elements known in the art, (for example, threads, detent or the like) for coupling. Fluid source outlet 116 includes coupling element (thread) 120 that is capable of being coupled to inlet 118 of adapter 104. Adapter inlet 118 or an inside portion of adapter 104 may include a complementary coupling element to allow adapter inlet 118 to mate with coupling element 120. One or more gaskets or a similar sealing device may be provided between fluid source outlet 116, coupling element 120 and adapter inlet 118. In some embodiments, adapter 104 may be permanently coupled to fluid source 102.

In some embodiments, adapter 104 includes a device for engaging an integrated valve of fluid source outlet 116. For example, adapter 104 includes a plunger capable of engaging a gating device of an integrated valve of fluid source outlet 116 when adapter 104 is coupled to fluid source 102. In some embodiments, the plunger of adapter 104 may be biased upward, away from integrated valve. Biasing the plunger may inhibit the plunger from engaging with the integrated valve when the adapter is initially coupled to fluid source 102, fluid source outlet 116 or coupling element 120. While coupled to source 102, the adapter plunger 104 may be moved downward toward the integrated valve of fluid source outlet 116, thereby engaging (depressing) the gating device of the integrated valve into an open position. Engaging the gating devices allows fluid (for example, refrigerant) to flow from fluid source 102. In some embodiments, adapter 104 includes a conduit (for example, a bore) that is in fluid communication with fluid source outlet 116 to allow fluid to flow from source 102, into and through adapter 104. In some embodiments, the conduit of adapter 104 extends through the adapter from adapter inlet 118 to adapter outlet 122. For example, the adapter plunger may be located in a bore and include orifices that allow fluid to pass through and/or around the adapter plunger when it is depressed to engage/depress the gating device of fluid source 102.

In some embodiments, adapter outlet 122 couples or directly connects to another adapter, valve, hose, or the like. Adapter outlet 122 includes couplers that are the same or similar to the couplers of fluid source outlet 116. Such couplers allow a valve or similar device capable of coupling to the fitting of fluid source outlet 116 to couple to adapter outlet 122. Connections may include, but are not limited to, threads, detent features, a combination thereof or the like. As shown, adapter outlet 122 includes a male-threaded coupling element that is capable of being coupled to valve inlet 124 of valve 108. In some embodiments, valve 108 includes an inlet that is complementary to adapter outlet 122. For example, valve inlet 124 may include an internally-threaded cavity that is capable of being threaded onto adapter outlet 122. In some embodiments, a gasket or similar sealing device may be provided between adapter outlet 122 and valve inlet 124. In some embodiments, valve 108 includes a bore that may be in fluid communication with a bore of adapter 104 and/or fluid source 102.

In some embodiments, coupling of valve 108, or a similar device (for example, hose 110), to adapter outlet 122 actuates adapter 104 and/or fluid source outlet 116 into an opened or closed position. For example, a bore of valve 108 may include a shoulder that engages a top portion of an adapter plunger, and thereby depressing the adapter plunger. When adapter 104 is coupled to fluid source 102, depressing the adapter plunger 168 may, in-turn, engage (for example, depress) the gating device of an integrated valve of fluid source 102 into an open position. Thus, opening fluid source 102. For example, opening the integrated valve of fluid source 102 may allow refrigerant to flow from fluid source 102 through adapter 104 to valve 108 and further to refrigeration system 114. In some embodiments, a gasket is provided at the shoulder to provide a seal between valve 108 and adapter 104 (for example, between the shoulder and the plunger and/or adapter outlet 122). In such an embodiment, the gasket may contact at least a portion of the gating device, thereby urging the gating device into an opened position.

Routing device 106 and/or valve 108 may include one or more devices used to regulate the flow of refrigerant from fluid source 102. In some embodiments, valve 108 may include a plunger 208 that advances longitudinally along a bore between an opened and closed position. The plunger may be advanced/retracted longitudinally between the opened and closed positions to regulate the flow (for example, flow-rate and/or pressure) of fluid being expelled from fluid source 102, through adapter 104, valve 108 and/or routing device 106. In some embodiments, plunger 208 includes a sharp/pointed tip configured to break a seal of a refrigerant container by piercing a hole in the seal. For example, valve 108 may include an inlet capable of coupling to an outlet of a refrigerant container, such that a piercing plunger may be advanced (downward) to engage and pierce a seal (for example, a foil/metal covering) of the refrigerant container, thereby creating an opening in the refrigerant allowing refrigerant to be expelled.

Adapter 104 may include a cavity that inhibits the piercing member of the routing device (for example, a piercing member of a valve) from contacting the gating device and/or seal of an integrated valve. For example, when valve inlet 124 is coupled to adapter outlet 122, a piercing member of the valve may be advanced (downward) into a cavity of adapter 104. In some embodiments, the cavity may be in a plunger of adapter 104. For example, when an adapter plunger is engaged (for example, depressed) by a portion of valve 108, a piercing member of the valve may be advanced/retracted within the cavity of the adapter plunger. In some embodiments, the piercing member does not engage (for example, contact) any portion of adapter 104. When valve 108 is coupled to adapter 104, the cavity of the adapter (for example, a cavity in the plunger) may provide a void region that enables the piercing member to be moved up and down when opening and closing valve 108. Valve 108 may have an actuator that allows fluid to flow through the valve. As shown in FIG. 1, valve 108 includes a handle 126. Handle 126 may be directly coupled to and/or integrally formed with a piercing member. Rotation of handle advances or retracts the piercing member into adapter 104. By coupling the adapter to a routing device having piercing members allows routing devices that were previously unsuitable for use with fluid sources having integrated valve.

As shown in FIG. 2, fluid source 102 includes fluid source body 128, fluid source outlet 116 and integrated valve 130. Integrated valve 130 may be partially positioned in fluid source body 128 and fluid source outlet 116. In some embodiments, fluid source outlet 116 may include a unitary assembly, including integrated valve 130, coupled to a top end of fluid source body 128. In some embodiments, integrated valve 130 is a self-sealing valve (SSV).

Fluid source outlet 116 may include lip 134. Lip 134 may round or curl over ends 136 of fluid source body 128. In some embodiments, lip 134 may be coupled over ends 136 via a press-fit, an adhesive, soldering, welding, or the like. In some embodiments, a gasket, or similar sealing device may be provided between lip 134 and ends 136 to provide a seal between the two. Coupling element 120 (for example, external thread) extends upward from fluid source body 128 (for example, from the top end of the outlet). In some embodiments, coupling element 120 includes a ½ inch (about 1.27 cm) ACME external thread or an ISO metric trapezoidal thread having a 30 degree thread angle. Coupling elements include, but are not limited to, various types and sizes of threads, detent feature, or the like. Channel 138 may be provided between lip 134 and coupling element 120. Channel 138 may accommodate/receive a portion of a device that is coupled to fluid source outlet 116. For example, channel 138 may be sized to accommodate the outside diameter of adapter inlet 118.

Integrated valve 130 may include gating device 140. In some embodiments, gating device 140 is a spring-loaded plunger. Gating device may be manipulated between an opened and closed position. For example, gating device 140 may be translated longitudinally between a closed position and an opened position as shown by arrow 142. As shown, gating device is in a closed position. Gating device 140 may be engaged/moved by an external device, such as plunger 144 of adapter 104. In some embodiments, gating device and the external device (adapter plunger 144) have complimentary dimensions.

Gating device 140 may be disposed in bore 146 of integrated valve 130. Seal 148 coupled to gating device 140 may seal against an inside annular surface of bore 146 when the plunger is disposed in a closed position. When moved downward, toward an opened position, a lower end portion of gating device 140 moves through opening 150, and seal 148 moves away from the inside annular surface of bore 146, thereby allowing refrigerant to flow from an interior of fluid source body 128 through bore 146 of fluid source outlet 116. In some embodiments, gating device 140 is biased in the opened or closed position. For example, in the illustrated embodiment, gating device 140 is biased into a closed position via a biasing member 152. In some embodiments, biasing member 152 includes a compressed coil spring.

It should be understood that fluid source outlet 116 may include various other configurations. For example, coupling element 120 may include an internal-thread, detent features, or the like, that provide for coupling to fluid source outlet 116. Further, embodiments of fluid source outlet 116 may include various configurations of integrated valves including other configurations of a plunger or similar sealing mechanism, such as those used in various types of aerosol type valves.

Adapter 104 may couple to fluid source outlet 116. Adaptor 104 may include a device capable of translating actuation of an engagement mechanism (for example, coupling of valve 108 to adapter 104) into actuation of integrated valve 130. Adapter 104 may also be capable of routing refrigerant from fluid source outlet 116 to an inlet of another device, such as valve 108, or the like.

Adapter 104 may include plunger 144 that engages gating device 140 and moves the gating device into an open position (for example, moves gating device 140 in FIG. 2 downward). In some embodiments, advancement of valve 108 onto adapter 104 engages plunger 144 with gating device 140 to open the gating device.

Body 154 of adapter 104 may include bore 156. Plunger 144 may be seated in bore 156. Bore 156 may include a passage that extends from adapter inlet 118 to adapter outlet 122. Bore 156 may provide for the passage of fluid from adapter inlet 118 to adapter outlet 122 through body 154. In some embodiments, at least a portion of bore 156 includes a straight cylindrical passage that extends from adapter inlet 118 to adapter outlet 122 through adapter body 154. Bore 156 may include a first bore portion 158 proximate adapter inlet 118 and a second bore portion 162 proximate adapter outlet 122. In some embodiments, first bore portion 158 includes a dimension (for example, a diameter) that is larger than a dimension of second bore portion 162.

In some embodiments, first bore portion 158 is sized to couple to fluid source outlet 116. An interior surface of first bore portion 158 may include coupling element 160 complementary to the coupling element 120 of fluid source 102 (for example, an internal thread of the adapter that mates with an external thread of the fluid source). Adapter 104 may be coupled to (for example, threaded onto) coupling element 120 of fluid source outlet 116. In some embodiments, coupling element 160 is selected to be the same size and type as that used with certain refrigerant containers. For example, coupling element 160 may be complementary to threading used on an R-134a refrigerant container. In certain embodiments, coupling element 160 is a ½ inch (about 1.27 cm) ACME female-thread or an International Standard Organization (“ISO”) metric trapezoidal thread having a 30 degree thread angle. Adapter plunger 144 may align with gating device 140 when adapter 104 is coupled to the fluid source.

Second bore portion 162 may extend from an upper end of first bore portion 158 to outlet adapter 122. Second bore portion 162 may be sized and/or have dimensions (for example, diameter) that enables the second bore portion to accept and guide adapter plunger 144 during use. For example, second bore portion 162 may include a cylindrical bore having an internal diameter slightly larger than an external diameter of a portion of adapter plunger 144 that extends into the second bore portion (for example, a head of adapter plunger 144).

Referring to FIG. 3, first bore portion 158 may include shoulder 164. Shoulder 164 may allow the first bore portion 158, bore 156, and second bore portion 162 to be fully integrated. Shoulder 164 may be sized to compensate for the difference in internal diameters of first bore portion 158 and second bore portion 162. Shoulder 164 may include a flat surface. Gasket/seal 166 in first bore portion 158 abuts shoulder 164. When coupling element 120 of fluid source outlet 116 is mated with adapter inlet 118, a portion of the coupling (for example, an upper portion of a thread) may extend proximate shoulder 164 and compress seal/gasket 166 between the portion of the coupling element and the shoulder. Such compression provides a seal for fluid communicating between portions of fluid source bore 146 (shown in FIG. 2) and bore 156. In some embodiments, seal/gasket 166 may include a rubber/metal disc washer, o-ring, or the like. In some embodiments, gasket/seal 166 is omitted.

In some embodiments, adapter 104 includes a stop and/or a biasing element. The stop may limit or inhibit downward movement of adapter plunger 144. Biasing element may hold adapter plunger 144 in a first position. In some embodiments, biasing element is a spring. In some embodiments, a stop and/or biasing element are not necessary.

As shown in FIGS. 2-4, adaptor 104 includes stop 174 and biasing element 176. Stop 174 may be positioned between first bore portion 158 and bore 156. Stop 174 may be positioned at or near a lower end of bore 156 proximate shoulder 164. In some embodiments, stop 174 protrudes into bore 156. Stop 174 may limit/inhibit movement of adapter plunger 144. Downward movement of adapter plunger 144 may be controlled by stop alone or in combination with biasing element 176. For example, downward movement of adapter plunger 144 may be limited by compression of biasing element 176 against stop 174.

Adapter plunger 144 includes plunger head 168 and plunger rod 170. Plunger head 168 may be depressed until a portion of the plunger head contacts stop 174. Plunger rod 168 may include protrusions 172. Protrusions 172 may contact stop 174 and inhibit/limit movement of plunger 144. Depressing of plunger head 168 may move plunger 144 from a first position to a second position. As shown in FIG. 4, adapter plunger 144 is in a second position in bore 156. In some embodiments, plunger head 168 is depressed until the plunger head aligns with a top of adapter outlet 122. In some embodiments, a surface of valve 108 (for example, a shoulder or a gasket) depresses plunger head 168 until the surface of the valve contacts a portion of coupling element 178 (for example, an upper portion).

Stop 174 includes opening 181 for the passage of plunger 144 through the stop. As shown in FIGS. 3 and 4 stop 174 includes opening 181 having plunger rod 170 passing there through. Opening 181 may include a shape similar/complementary to a shape of plunger rod 170. For example, when plunger rod 170 has a cylindrical shape, opening 181 may include a cylindrical passage having an internal diameter slightly larger than the outside diameter of plunger rod 170.

In some embodiments, stop 174 includes one ore more passages/orifices that facilitate passing refrigerant though bore 156. Stop 174 may include a plurality of (for example, two, three, four, or ten) holes 180 that extend through stop 174. Embodiments may include any number and type of passages/orifices/holes.

In some embodiments, stop 174 is formed integrally with bore 156. For example, surrounding first bore portion 158 and second bore portion 162 of bore 156 may be milled out of material, forming stop 174. In certain embodiments, stop 174 may be provided as a separate piece that is assembled into bore 156. For example, stop may be press-fitted, welded, soldered, or glued using an adhesive or otherwise attached/bonded to an interior of bore 156.

In some embodiments, bore 156 terminates at or near adapter outlet 122. Second bore portion 162 may extend through and terminate at adapter outlet 122. Bore 156 may extend through coupling element 178 of adapter outlet 122. Adapter coupling element 178 may be the same or similar to the coupling elements of valve 108 (for example, threads). In some embodiments, threading 183 may be selected to be the same size and type as that used with certain refrigerant containers. For example, adapter coupling element 178 may include a threaded portion that is the same as that used on an R-134a refrigerant container. In some embodiments, adapter coupling element 178 includes a ½ inch (about 1.27 cm) ACME external thread or an ISO metric trapezoidal thread having a 30 degree thread angle.

Adapter 104 may include first lip/protrusion 182 and second lip/protrusion 184. First lip/protrusion 182 extending from body 154 and around adapter coupling element 178. First lip/protrusion 182 may help to shield connection of devices to adapter outlet 122 from damage during use and/or may help to provide for alignment of devices (for example, valve 108) to adapter outlet 122 during use. First lip/protrusion 182 may include channel 186 between first lip/protrusion 182 and coupling element 120. Channel 186 may accommodate/receive a portion of a device that is coupled to adapter outlet 122. For example, channel 186 may be sized to accommodate the outside diameter of an inlet of valve 108 coupled to adapter outlet 122. In some embodiments, channel 186 is omitted.

Second lip/protrusion 184 may extend from body 154 and around adapter inlet 118. Second lip/protrusion 184 may help to shield connection of devices to adapter inlet 118 from damage during uses and/or may help to provide for alignment of devices (for example, fluid source 102) to adapter inlet 118 during use. Second lip/protrusion 184 may include channel 188 between the second lip/protrusion and adapter inlet 118. Channel 188 may accommodate/receive a portion of a device that is coupled to adapter outlet 122. For example, channel 188 is sized to accommodate lip 134 of fluid source outlet 116 when fluid source 102 is coupled to adapter 104. In some embodiments channel 188 is omitted.

During use, adapter plunger 144 may be advanced or retracted as depicted by arrow 190. For example, during advancement, plunger head 168 of plunger 144 is advanced downward through second bore portion 162, and plunger rod 170 is advanced downward through opening 181 of stop 174 into first bore portion 158 and through adapter outlet 118 (see, for example FIG. 4). When fluid source outlet 116 (shown in FIGS. 1 and 2) is coupled to adapter inlet 118, engagement end 192 of plunger rod 170 may engage/actuate integrated valve 130 into an opened or closed position. For example, when adapter plunger 144 is advanced, engagement end 192 of the adapter plunger may contact a top surface of gating device 140 (shown in FIG. 2), thereby advancing (for example, moving/pushing) gating device 140 from a closed position to an opened position.

In some embodiments, engagement end 192 includes a smooth, rounded or blunt shape capable of engaging and moving gating device 140 of integrated valve 130. Engagement end 192 may be complementary to gating device 140 such that the engagement end engages the gating device without damaging the plunger (for example, without piercing or scratching a surface of gating device 140). Engagement end 192 may include a substantially flat surface having a chamfered edge. In some embodiments, engagement end 192 includes a completely flat surface, curved surface (for example, hemispherical surface), or the like.

Stop 174 may include a retaining member. The retaining member may inhibit adapter plunger 144 from sliding out of adapter 104. In some embodiments, a retaining member is not necessary. As shown in FIGS. 3 and 4 stop 174 includes a sleeve as a retaining member. Sleeve 194 may coupled to stop 174 using methods known in the art (for example, welded, glued, epoxied or the like). Sleeve 194 may inhibit plunger 144 from sliding out of adaptor 104. For example, protrusions 172 of plunger rod may contact sleeve 174. During use, sleeve may serve as a guide for plunger rod 170. Sleeve may have be shaped (for example, have a cylindrical shape) and be sized to accept recess 196 of plunger rod 170 (shown in FIG. 4). Engaging recess 196 with sleeve 194 may inhibit plunger 144 from sliding out adapter outlet 122 and/or hold plunger rod 170 in place. In some embodiments, sleeve 194 is omitted. In some embodiments, sleeve 194 is coupled to plunger rod 170.

In some embodiments, adapter plunger 144 is disposed in bore 156. In some embodiments, adapter plunger 144 is biased into an opened position. As shown in FIG. 3, adapter plunger 144 is biased by biasing element 176 upward such that an end of plunger 144 (for example, engagement end 192) used to engage gating device 140 of integrated valve 130 during use, does not engage the gating device while adapter 104 is coupled to fluid source 102. In some embodiments, biasing element 176 may be held in compression due to sleeve 194 contacting (for example, bottoming out) on stop 174.

Plunger head 168 may accept a complementary portion of another device. For example, plunger head 168 may accept valve plunger 208 (shown in FIG. 2). Valve plunger 208 may include a pointed end capable of breaking a seal and/or damaging components of an integrated valve. Plunger head 168 may include cylindrical cavity 198 that extends from top end 200 to base 202 proximate an upper end of plunger rod 170. In some embodiments, cavity 198 includes a void region that enables valve plunger 208 (shown in FIG. 2) to be advanced/retracted within cavity 198. In some embodiments, valve plunger 208 may not contact any portion of adapter plunger 144 during use. For example, when valve 108 is coupled to adapter 104, adapter plunger 144 may be depressed via a body/shoulder/gasket of valve 108 into a depressed (for example, opened) position, and valve plunger 208 may be advanced/retracted (for example, between opened and closed positions), without the valve plunger contacting the adapter plunger. In some embodiments, valve plunger 208 may be advanced downward into engagement with the solid surface of base 202. In some embodiments, a sealing device (for example, a gasket or -ring) is provided between plunger head 168 and second bore portion 162.

Base 202 may include one or more holes (orifices /passages) 204 that facilitate refrigerant passing though plunger 144. Base 202 may include a plurality (for example, two, three, four or ten) of holes 204 that are complimentary and/or align with holes 180 of stop 174. Embodiments may include any number and type of holes. Refrigerant may pass through base 202 via holes 204 and may travel into the annular region between an external surface of valve plunger 208 and an internal surface of plunger head 168.

Referring to FIG. 2, valve 108 includes body 206. In some embodiments, other types of pressure gauges or other pressure measurement devices maybe used instead of valve 108. In some embodiments, handle 126 may be used to operate valve 108. In some embodiments, handle 126 may be integrated with a pressure gauge and/or temperature gauge, or similar devices. Handle 126 may be coupled to valve plunger 208. In some embodiments, handle 126 may include ridges and/or other features that allow a user to grip and rotate a valve plunger 208 to actuate valve 108. Valve plunger 208 may be coupled to handle 126 such that the valve plunger rotates when the handle is turned. In some embodiments, valve plunger 208 may be permanently coupled to handle 126. For example, valve plunger 208 may be bonded (for example, glued, epoxied, or welded) to handle 126. Valve plunger 208 may be made of materials chemically inert to refrigerant (e.g., stainless steel or aluminum).

Valve plunger 208 and handle 126 may be coupled to valve body 206 with nut 210. Nut 210 may be a retainer nut. An inside diameter of a portion of nut 210 may be slightly larger than the outside diameter of valve plunger 208 to allow nut 210 to move freely up and down the body of the valve plunger. A portion of nut 210 may have an inside diameter that is less than a diameter of valve plunger 208 at threads 212 to inhibit the nut from passing over threads 212. Gasket 214 may be located inside nut 210 to provide a seal between plunger 208, nut 210, and valve body 206 of valve 108. Gasket 214 may be made of one or more materials that are chemically inert to fluid in valve 108.

Valve plunger 208 may include threads 212. Threads 212 may engage threads 216 of valve body 206 such that rotation of valve handle 126 rotates valve plunger 208. Rotation of valve plunger 208 may cause the valve plunger to move along threads 216 and translate relative to valve body 206. As valve plunger 208 translates relative to valve body 206, the valve plunger may form a seal when pressed against seat 218. A portion of valve plunger 208 that presses against seat 218 may be complementary to the shape of the seat to allow a tight seal to be formed between the valve plunger and the seat. Sealing valve plunger 208 against seat 218 may provide a closed position that inhibits flow of fluids between a source (for example, fluid source 102 and/or adapter 104) and a device (for example, a hose or a refrigeration system) coupled to valve 108. Thus, valve 108 may operate as a shutoff valve between fluid source 102 and refrigeration system 114 (for example, fluid source body 128 and hose 110 in FIG. 1).

In certain embodiments, valve plunger 208 may include tip 220. Tip 220 may be a piercing tip (for example, a sharp/pointed tip capable of piercing a refrigerant container). Tip 220 may be used to advance adapter plunger 144 and/or pierce a refrigerant container or other refrigerant container coupled to valve 108. Tip 220 may be formed of hardened material (for example, stainless steel). In an embodiment, valve plunger 208, including tip 220, is made of one material as a single formed body. In some embodiments, valve plunger 208 may be made of two or more pieces.

Valve 108 may include thread 222. Thread 222 may be used to couple valve 108 to an external thread of adapter outlet 122. Adapter outlet 122 may have a thread portion that mates with thread 222. In some embodiments, thread 222 includes a dimension and type complementary to the dimension and type of thread of adapter outlet 122. For example, thread 222 may include a ½ inch (about 1.27 cm) ACME internal thread or an ISO metric trapezoidal thread having a 30 degree thread angle.

In some embodiments, thread 222 may be selected to mate exclusively with a threaded portion of certain refrigerant containers. For example, thread 222 may only mate with a threaded portion of an R-134a refrigerant container. In some embodiments, thread 222 may be external and/or formed as a part of valve body 206.

Inlet 124 of valve 108 may include a shoulder formed in valve body 206. As shown, a cavity including internal thread 222 terminates into shoulder 224. Shoulder 224 includes a radially extending flat surface that necks down into bore 226 through valve body 206. In some embodiments, valve shoulder 224 engages (for example, depresses) adapter plunger 144 when valve 108 is coupled to adapter outlet 122. For example, when valve inlet 124 is threaded onto adapter inlet 118, valve 108 may be advanced longitudinally until shoulder 224 contacts adapter coupling element 178 (for example, a top end of the coupling element 178). Valve shoulder 224 may also contact top end 200 of adapter plunger 144, thereby advancing adapter plunger 144 into gating device 140. In an embodiment, in which valve shoulder 224 includes a relatively flat surface, top end 200 of adapter plunger 144 may be advanced to be even or nearly even with a top portion of coupling element 178 when shoulder 224 contacts the coupling element.

Valve 108 includes a gasket. Gasket 228 may be used to provide a seal between the valve body and devices mated with the valve inlets and/or outlets. Gasket 228 may be used to provide a seal between valve body 206 and a device mated with valve inlet 124. Gasket 228 may contact or otherwise provide an intermediate interface between shoulder 224 and top end 200 of adapter plunger 144 and/or a top end of coupling element 178. Gasket 228 may include a rubber/metal disc washer, o-ring, or the like. Gasket 228 may be made of one or more materials that are chemically inert to fluid from the refrigerant container. In some embodiments, gasket 228 is shoulder 224. In some embodiments, gasket 228 is omitted.

Components of valve 108 may be made of one or more materials chemically inert to fluid (for example, refrigerant) used in a refrigerant system. In certain embodiments, valve body 206 may include two or more pieces of differing materials that are coupled (for example, bonded). In some embodiments, valve body 206 may have a plastic outer portion coupled to or bonded over a metal (for example, brass) interior portion.

In some embodiments, valve 108 may include a hose coupler. Valve body 206 may couple to and/or include hose coupler 230. Hose coupler 230 may be, for example, a hose barb, threading, or other device for coupling hose 110 to valve 108. In certain embodiments, hose 110 may be permanently attached to hose coupler 230. For example, hose 110 may be crimped to hose coupler 230 (for example, the hose may be crimped over the hose coupler using a metal crimp sleeve). Hose 110 may be coupled to hose coupler 230 using any method known in the art.

In some embodiments, adapter 104 includes plunger 144 adapter plunger 144 includes a retaining clip. The retaining clip may inhibit or limit movement of adapter plunger 144 in adapter bore 156. A shape of the retaining clip may be circular, wave, spiral or the like. Retaining clip may be positioned on plunger head 168 of adapter plunger 144. Positioning of retaining clip on plunger head 168 may inhibit or limit a portion of the plunger head from entering second bore portion 162 of adapter 104. The retaining clip may also serve as a stop during use. For example, retaining clip may contact an outer surface of integrated valve 130 when plunger 144 is depressed.

FIG. 5 depicts adapter 104 coupled to valve 108 containing valve plunger 208. Adapter 104 includes plunger 144 positioned in adapter bore 156. Plunger 144 may include plunger head 168, plunger rod 170, plunger pin 232 and retaining clip 234. The outer diameters of plunger head 168, plunger rod 170 and plunger pin may vary. The outer diameters of the three components decrease so that plunger pin 232 has the smallest outer diameter. For example, plunger head 168 has a larger outer diameter than plunger rod 170 and the plunger rod has a larger diameter than plunger pin 232. When fluid source outlet 116 (shown in FIGS. 1 and 2) is coupled to adapter inlet 118, engagement plunger pin 232 may engage/actuate integrated valve 130 into an opened or closed position. For example, when adapter plunger 144 is advanced, plunger pin 232 may contact a top surface of gating device 140 (shown in FIG. 2), thereby advancing (for example, moving/pushing) gating device 140 from a closed position to an opened position.

In some embodiments, plunger pin 232 includes end 236. Plunger pin end 236 may have smooth, rounded or blunt shape capable of engaging and moving gating device 140 of integrated valve 130. Plunger pin end 236 may be complementary to gating device 140 such that the engagement end engages the gating device without damaging the plunger (for example, without piercing or scratching a surface of gating device 140). Plunger pin end 236 may include a substantially flat surface having a chamfered edge. In some embodiments, plunger pin end 236 includes a completely flat surface, curved surface (for example, hemispherical surface), or the like.

Retaining clip 234 may be positioned on a lower portion of plunger rod 170 disposed in first bore section 158 of adapter 104. Retaining clip 234 may inhibit a portion of plunger 144 from entering second bore section 162 of adapter 104. Using retaining clip 234 may allow plunger 144 to be held in place without biasing element 176.

In some embodiments, plunger 144 travels along first bore section 158, when not attached to routing device 106. Advancement of routing device 106 or valve 108 onto coupling element 178 of routing device 106 moves plunger rod 170 downward (as shown by arrow 190) and into integrated valve 130 of fluid source 102 (not shown). In some embodiments, a biasing element is provided around plunger rod 170. For example, between retaining clip 234 and plunger head base 202.

In some embodiments, components of plunger 144 may be removably coupled. FIG. 6 depicts an exploded perspective view of plunger 144 with removably coupled plunger head 168 and plunger rod 170. Plunger head 168 may include coupling element 236 that mates with coupling element 238 of plunger rod 170. As shown, coupling elements 236, 238 are threads, however, the coupling elements may be any coupling element known in the art, (for example, clips, detent or the like). In some embodiments, a sealing additive may be applied to coupling elements 236, 238. For example, glue, sealing tape, epoxy or other additives may be applied to the coupling elements to ensure that plunger head 168 secures to plunger rod 170.

Plunger head 168 includes recess 240. Recess 240 allows sealing device 242 to fit around plunger head 168. Sealing device 242 may include, but is not limited to, a gasket, o-ring, or the like. Sealing device 242 may inhibit fluid for fluid source 202 from flowing between plunger head 168 and second bore portion 162 when plunger pin 232 is engaged with integrated valve 140. Plunger pin 232 may have the same or smaller outer diameter as plunger rod 170.

Plunger rod 170 includes stop 174. Stop 174 may be formed integrally with plunger rod 170 and plunger pin 232. For example, plunger rod 170, stop 174 and plunger pin 232 may be formed as one piece. In certain embodiments, stop 174 may be provided as a separate piece that is assembled into plunger rod 170. For example, stop may be press-fitted, welded, soldered, or glued using an adhesive or otherwise attached/bonded to plunger rod 170. Stop 174 may limit/inhibit movement of adapter plunger 144. In some embodiments, stop 174 is positioned between plunger rod 170 and plunger pin 232 so that when plunger pin 232 is fully extended into integrated valve 130 a portion of the stop contacts fluid source outlet 116. Fluid from fluid source 102 may flow through flow holes 180 of stop 174 and through holes 204 of plunger head 168 as shown by arrows 244. Plunger pin 232 may include slot 246. Slot 246 may mate with a tool (for example, a screwdriver) to allow plunger rod 170 to be coupled or inserted into plunger head 168. In some embodiments, slot 246 is omitted.

Downward movement of adapter plunger 144 may be controlled by stop alone or in combination with biasing element 176. For example, downward movement of adapter plunger 144 may be limited by compression of biasing element 176 against stop 174. Plunger head 168 may be depressed until a portion of the biasing element 176 is compressed against stop 174. In some embodiments, biasing element 176 is omitted and plunger head 168 is depressed until the plunger head contacts stop 174.

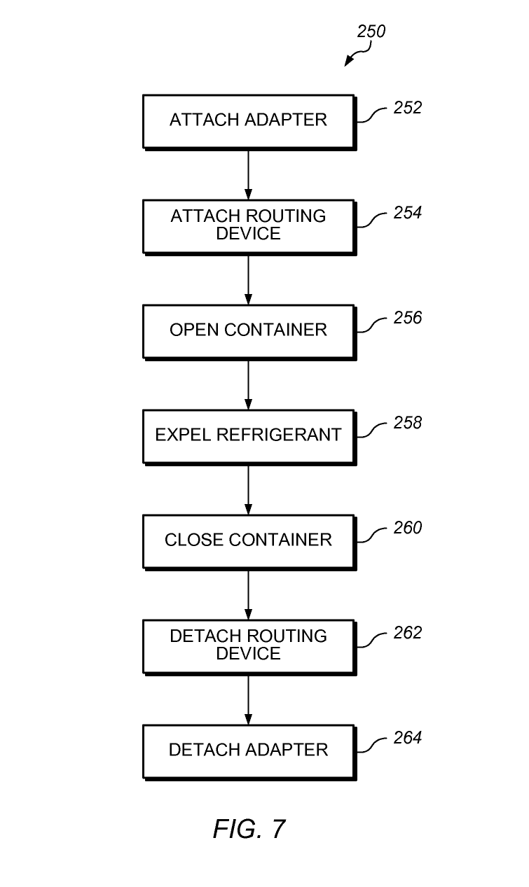

FIG. 7 is a flowchart that illustrates a method 250 of allowing fluid flow from a fluid source to a receiving system. In some embodiments, the fluid source is a refrigerant and the receiving system is a refrigeration system. The flow of fluid charges the refrigeration system. In FIG. 6, block 252 depicts adapter 104 being attached to one or more devices that deliver fluid from a fluid source to a receiving system (for example, a refrigerant system). For example, adapter 104 is attached to fluid source 102 by threading adapter inlet 118 onto coupling element 120 of fluid source 102. In some embodiments, the adapter plunger is biased into a retracted position such that the engagement end of the adapter plunger does not actuate (for example, open) the integrated valve of the fluid source (for example, the position of plunger 144 in FIG. 3).

As depicted by block 254, the adapter is attached to the valve after attachment to the fluid source. In some embodiments, the valve inlet is partially threaded onto the outlet of the adapter, thus allowing the valve inlet to be attached to the adapter prior to coupling the adapter to the fluid source. In some embodiments, attaching an adapter includes coupling the adapter to the routing device and/or the refrigerant system (see for example, FIG. 1). In some embodiments, attaching a routing device includes coupling the valve 108 to the adapter and then coupling hose 110 to port 112 of refrigerant system 114. In some embodiments, a connection, such as a hose or conduit, having similar features is coupled to an adapter.

After attaching the adapter (for example, adapter 104 in FIGS. 1-6) to one or more devices for delivery of fluid from a fluid source, the fluid source may be opened, as depicted by block 256. In some embodiments, opening the fluid source includes opening a refrigerant container. Opening the fluid source may include advancing a routing device onto the adapter (for example, threading valve 108 onto adapter 104, or advancing a shoulder of a hose or conduit onto adapter 104) such that a shoulder and/or a gasket of the routing device engages (for example, advances) a plunger of the adapter (for example, adapter plunger 144). The routing device may be advanced onto the adapter to move adapter plunger through the adapter outlet to contact the integrated valve of the fluid source. For example, contact of plunger engagement end 192 with gating device 140 of integrated valve 130 in FIG. 2. Further advancement of the routing device advances the adapter plunger and opens the integrated valve, thereby opening the fluid source. Opening the integrated valve may allow fluid (for example, refrigerant) to be expelled from the fluid source (shown as block 258). In some embodiments, during opening of the fluid source, the valve plunger is in a closed position so that when the integrated valve is opened, the fluid is inhibited from being expelled through the valve. In certain embodiments, a hose or conduit having a shoulder at an inlet is coupled to an outlet of an adapter and the flow of fluid is regulated by a valve connected to the hose or conduit.

In some embodiments, expelling fluid (for example, refrigerant) includes routing the fluid from the fluid source to a receiving system (for example, a refrigeration system or another container). For example, with integrated valve 130 opened, valve handle 126 may be rotated to advance valve plunger 124 into the opened position, thereby allowing refrigerant to flow from fluid source 102 to refrigerant system 114 via adapter 104 and routing device 106 connected to port 112. In some embodiments, refrigerant may be allowed to flow until a desired pressure is reached and/or substantially all of the refrigerant in the fluid source is used. The routing device (for example, valve 108) may be varied between the opened and closed positions to regulate the flow of fluid (for example, flow-rate and pressure of refrigerant) being delivered to a receiving system (for example, a refrigeration system).

In some embodiments, the routing device coupled to the adapter move relative to one another to advance and retract the adapter plunger and integrated valve gating device, thereby regulating the flow of refrigerant from the fluid source. For example, valve 108 may be threaded farther down/onto adapter coupling element 178 advancing adapter plunger 144 and engaging gating device 140 into a downward position. Thus, allowing more fluid to flow from fluid source 102. Alternatively, advancing valve 108 farther up/off of adapter 104 disengages or retracts adapter plunger 144 from gating device 140 moving the gating device upward (closed). Thus, less fluid or substantially no fluid flows from fluid source 102. Accordingly, flow may be regulated via advancement of valve body 206, or a similar device coupled to adapter outlet 122, such as a hose and/or conduit coupled to adapter outlet 122. Fluid flow may be regulated in a similar fashion using a hose or conduit with a shoulder coupled to the adapter.

In some embodiments, method 250 includes closing the container, as depicted at block 260. In some embodiments, closing a container includes closing the routing device. For example, handle 126 of valve 108 may be rotated such that valve plunger 208 is advanced into the closed position. In some embodiments, closing the fluid source includes at least partially disengaging the routing device (for example, valve body or a shoulder of a hose) to disengage or partially disengage the adapter plunger from the integrated valve of the fluid source, thereby closing or at least partially closing the fluid source. For example, valve body 206 may be unthreaded from adapter outlet 122 to disengage or partially disengage adapter plunger 144 from gating device 140. Thus, closing integrated valve 130 and inhibiting the flow of fluid (for example, refrigerant) from fluid source 102 (for example, a refrigerant can). In some embodiments, the fluid source may be closed when the adapter and routing device are uncoupled from the fluid source as one unit (for example, unthreading adapter 104 from fluid source 102 while the adapter is connected to valve 108 and/or routing device 106 or removing a hose/conduit coupled to the adapter).

In some embodiments, method 250 includes detaching the routing device, as depicted at block 262. In some embodiments, detaching the routing device may include uncoupling a connector of a routing device or a valve from the adapter. In some embodiments, detaching the routing device includes detaching a valve or a hose/conduit from the adapter. Uncoupling of a routing device from the adapter may allow the adapter plunger to substantially retract due to the biasing force of the biasing element.

In some embodiments, the adapter is removed from the fluid source, as depicted in block 264. Detaching the adapter may include uncoupling the adapter from the fluid source. When the adapter is detached from the fluid source, the integrated valve advances to a closed position. Use of the adapter in combination with a fluid source having an integrated valve may inhibit fluid (for example, refrigerant) from escaping the fluid source. Thus, a user may use only a portion of a container of fluid. In some embodiments, the adapter and routing device are uncoupled from the fluid source as one unit (for example, unthreading adapter 104 from fluid source 102 while the adapter is connected to routing device 106 and/or valve 108).

In some embodiments, one or more portions of the described system may be provided individually, or as a kit. For example, fluid source 102, adapter 104, routing device 106, valve 108, and hose 110 depicted in FIGS. 1-6 may be provided individually. In some embodiments, any combination of one or more of fluid sources, adapters, routing devices, valves, hoses, or other components (for example, pressure gauges, lights, safety goggles, or the like), may be provided together. For example, fluid source 102, adapter 104, valve 108, hose 110 may be provided in a single package (for example, a bag, a shrink wrap, a bubble wrap, box, or the like). In some embodiments, the adapter, the valve, and/or the hose, may be provided in a single package. Thus, a user may purchase one or more of the components in kit form.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed is:

1. An adapter, comprising:
an inlet configured to engage an outlet of a fluid source, the fluid source comprising an integrated valve capable of being moved to an opened position or a closed position;
an outlet engageable with an inlet of a routing device comprising a valve;
a passage in a body of the adapter, the passage extending between the inlet and the outlet of the adapter;
a plunger disposed in the passage, the plunger configured to engage the integrated valve of the fluid source and the valve of the routing device during use, wherein the plunger couples the movement of the valve of the routing device to the integrated valve of the fluid source such that the integrated valve is moved to an opened position or a closed position when the valve of the routing device is moved to an opened or closed position during use.

2. The adapter of claim 1, wherein the plunger comprises a blunt portion configured to engage a plunger of the integrated valve.

3. The adapter of claim 1, wherein a second end of the plunger comprises a cavity configured to receive a portion of the valve of the routing device.

4. The adapter of claim 1, wherein a second end of the plunger comprises a cavity configured to receive a portion of the valve of the routing device member, and wherein the cavity is configured to inhibit contact of the valve of the routing device member with the integrated valve.

5. The adapter of claim 1, wherein the inlet of the adapter comprises a coupling element a complimentary coupling element of the fluid source outlet.

6. The adapter of claim 1, further comprising a stop disposed in the passage, wherein the stop is configured to inhibit translation of the plunger.

7. The adapter of claim 1, further comprising a stop disposed in the passage wherein the stop comprises openings extending there through for the passage of fluid.

8. The adapter of claim 1, further comprising a stop and a biasing member disposed in the passage, wherein the stop is configured to inhibit translation of the plunger and wherein the biasing member comprises a spring disposed between the stop and an end of a head of the plunger.

9. The adapter of claim 1, further comprising a stop disposed in the passage, wherein the plunger comprises a protrusion between the stop and an end of the plunger, and wherein the protrusion is configured to engage the stop to inhibit translation of the plunger.

10. The adapter of claim 1, wherein the valve of the routing device comprises the member capable of breaking a seal.

11. The adapter of claim 1, wherein the fluid source comprises a pressurized container of refrigerant.

12. The adapter of claim 1, wherein the a passage extending between the inlet and the outlet comprises a first bore portion proximate the inlet, the first bore portion having a first diameter, and a second bore portion proximate the outlet, the second bore portion having a second diameter that is less than the first diameter.

13. The adapter of claim 14, wherein the first end of the plunger comprises a rod member disposed in the first bore portion, and the second end of the plunger comprises a head portion disposed in the second bore portion.

14. The adapter of claim 1, wherein coupling of the routing device to the outlet advances the plunger from a first position to a second position such that plunger engages the integrated valve, during use.

15. The adapter of claim 1, further comprising, a biasing member configured to bias the adapter plunger into a first position.

16. The adapter of claim 1, wherein the plunger comprises one or more removably coupled components.

17. The adapter of claim 1, further comprising a stop coupled to a plunger rod of the plunger, wherein the stop is configured to inhibit translation of the plunger.

18. The adapter of claim 1, wherein the plunger comprises a plunger head removably coupled to a plunger rod of the plunger.

19. The adapter of claim 1, wherein the plunger comprises a plunger head removably coupled to a plunger rod of the plunger, plunger rod comprising a stop and a plunger pin, wherein the stop is configured to inhibit translation of the plunger head, and the plunger pin is configured to engage an integrated valve of the fluid source.

20. The adapter of claim 1, wherein the plunger comprises a plunger head removably coupled to a plunger rod of the plunger, the plunger rod comprising a stop and a plunger pin, wherein the stop is configured to inhibit translation of the plunger head, and the plunger pin is configured to engage an integrated valve of the fluid source and wherein the plunger head comprises a recess configured to hold a sealing device.

21. A refrigerant source adapter, comprising:
a first end configured to couple to an outlet of a refrigerant source having an integrated valve;
a second end configured to couple to an inlet of a valve having a piercing tip;
a passage that extends between the first end and the second end; and
a plunger disposed in the passage, wherein a first end of the plunger is configured to receive the piercing tip and a second end of the plunger is configured to engage the integrated valve.

22. A kit for servicing a refrigeration system, comprising:
a routing device comprising a member capable of breaking a seal of a refrigerant source; and
an adapter couplable to the integrated valve of a refrigerant source and to the routing device, the adapter comprising a plunger configured to receive the member capable of breaking a seal of a refrigerant source and a second end of the plunger is configured to engage the integrated valve.

23. The kit of claim 22, further comprising the refrigerant source comprising the integrated valve.

24. A method, comprising:
providing an adapter to an integrated valve of a fluid source; wherein the adapter comprises a plunger, the plunger having a first end capable of inhibiting a piercing member of a routing device from breaking a seal of the integrated valve;
providing the routing device to the adapter;
advancing a second end of the plunger into the integrated valve; and
allowing fluid to flow from the fluid source to a receiving system coupled to the routing device.

25. The method of claim 24, wherein the fluid source comprises refrigerant, and the receiving system comprises a refrigeration system.

26. The method of claim 24, further comprising opening or closing the member of the routing device to regulate the flow of refrigerant from the fluid source.

27. The method of claim 24, further comprising coupling the routing device to a hose.

28. The method of claim 24, wherein the routing device comprises a valve.

29. The method of claim 24, wherein the routing device comprises a valve and hose.

30. The method of claim 24, wherein the fluid source is pressurized.

31. The method of claim 24, wherein the plunger further comprises a cavity configured to receive the routing device member capable of breaking a seal, and wherein advancing the second end of the plunger into the integrated valve, the cavity inhibits contact of the routing device member with the integrated valve.

32. The method of claim 24, further comprising at least partially closing the integrated valve by at least partially retracting the adaptor plunger from the fluid source.

33. The method of claim 24, wherein allowing fluid to flow comprises adjusting a position of the routing device member in the plunger.
